(19) United States
(12) Patent Application Publication
(10) Pub. No.: US 2025/0147640 A1
(43) Pub. Date: May 8, 2025

(54) METHOD AND APPARATUS FOR DISPLAYING COLLABORATIVELY EDITED INFORMATION, ELECTRONIC DEVICE AND READABLE MEDIUM

(71) Applicant: Beijing Feishu Technology Co., Ltd., Beijing (CN)

(72) Inventors: Guangping XIE, Beijing (CN); Liang QIAO, Beijing (CN); Manting CHEN, Beijing (CN)

(21) Appl. No.: 18/833,348

(22) PCT Filed: Jan. 10, 2023
(86) PCT No.: PCT/CN2023/071656

§ 371 Date: Jul. 25, 2024

(30) Foreign Application Priority Data
Jan. 27, 2022 (CN) 202210103777.5

(51) Int. Cl. G06F 3/0483; G06F 3/0484

(52) U.S. Cl. CPC G06F 3/0483; G06F 3/0484

(57) ABSTRACT

Embodiments of the disclosure provide a method and apparatus for displaying collaboratively edited information, an electronic device, and a readable medium. The method includes: determining, in response to an operation of moving an operation focus to a first content block in an online document by a first collaborative editor, a first identifier display area corresponding to the first content block; and displaying an identifier of the first collaborative editor in the first identifier display area. The first content block is a collaboratively editable content block. Content blocks in the online document are in a one-to-one correspondence with identifier display areas. The first identifier display area is positioned outside the first content block. At least part of an identifier of each collaborative editor is displayed in the first identifier display area. Information about collaborative editors participating in collaborative editing of any content block in the online document can be accurately determined.

### CROSS REFERENCE TO RELATED APPLICATION

The present disclosure claims priority of the Chinese patent application No. 202210103777.5, entitled “METHOD AND APPARATUS FOR DISPLAYING COLLABORATIVELY EDITED INFORMATION, ELECTRONIC DEVICE AND READABLE MEDIUM” and filed on Jan. 27, 2022, which is incorporated herein by reference in its entirety.

### FIELD

The present disclosure relates to the technical field of collaborative editing, and particularly relates to a method and apparatus for displaying collaboratively edited information, an electronic device and a readable medium.

### BACKGROUND

An online document application is an application that supports multi-person collaborative editing. A plurality of users can edit a same document in real time through the online document application. For example, the plurality of users can collaboratively edit content of the document.

When a plurality of collaborative editors edit a same online document, information about the collaborative editors can be displayed in the online document. The inventors have found that in the related art, when information about collaborative editors is displayed in an online document, a user cannot accurately identify information about collaborative editors participating in collaborative editing of any content block in the online document.

### SUMMARY

This Summary section is provided to introduce the concepts in a simplified form that are described in detail in the section of Detailed Description. This Summary section is not intended to define key features or essential features of the claimed technical solutions, nor is it intended to be used to limit the scope of the claimed technical solutions.

Embodiments of the present disclosure provides a method and apparatus for displaying collaboratively edited information, an electronic device and a readable medium, which at least partially solve the above technical problem.

According to a first aspect, an embodiment of the present disclosure provides a method for displaying collaboratively edited information. The method includes: determining, in response to an operation of moving an operation focus to a first content block in an online document by a first collaborative editor, a first identifier display area corresponding to the first content block; and displaying an identifier of the first collaborative editor in the first identifier display area. Content in the first content block is collaboratively editable. The first identifier display area is positioned outside the first content block. At least part of an identifier of each collaborative editor is displayed in the first identifier display area.

According to a second aspect, an embodiment of the present disclosure provides an apparatus for displaying collaboratively edited information. The apparatus includes a response unit configured to determine, in response to an operation of moving an operation focus to a first content block in an online document by a first collaborative editor, a first identifier display area corresponding to the first content block; and a display unit configured to display an identifier of the first collaborative editor in the first identifier display area. Content in the first content block is collaboratively editable. The first identifier display area is positioned outside the first content block. At least part of an identifier of each collaborative editor is displayed in the first identifier display area.

According to a third aspect, an embodiment of the present disclosure provides an electronic device, including one or more processors; and a storage apparatus configured to store one or more programs. The one or more programs, when executed by the one or more processors, enable the one or more processors to implement the method for displaying collaboratively edited information according to the first aspect.

According to a fourth aspect, an embodiment of the present disclosure provides a computer-readable medium storing a computer program. The program, when executed by a processor, implements steps of the method for displaying collaboratively edited information according to the first aspect.

### BRIEF DESCRIPTION OF THE DRAWINGS

The foregoing and other features, advantages, and aspects of embodiments of the present disclosure will become more apparent in conjunction with the accompanying drawings and with reference to the following specific implementations. Throughout the accompanying drawings, same or similar reference numerals indicate same or similar elements. It should be understood that the accompanying drawings are schematic and that parts and elements are not necessarily drawn to scale.

FIG. 1 is a flowchart of an embodiment of a method for displaying collaboratively edited information according to the present disclosure;

FIG. 2 to FIG. 5 are schematic diagrams of displaying information about collaborative editors participating in collaborative editing according to the present disclosure;

FIG. 6 is a schematic structural diagram of an embodiment of an apparatus for displaying collaboratively edited information according to the present disclosure; and

FIG. 7 is a schematic diagram of a basic structure of an electronic device according to an embodiment of the present disclosure.

### DETAILED DESCRIPTION

The embodiments of the present disclosure will be described below with reference to the drawings. Although the drawings illustrate some embodiments of the present disclosure, it should be understood that the present disclosure may be implemented in various forms, and is not limited to the embodiments set forth herein. It should be understood that the drawings and the embodiments of the present disclosure are only used for illustrative purposes and are not intended to limit the protection scope of the present disclosure.

It should be understood that the steps described in the method embodiments of the present disclosure may be executed in different sequences and/or in parallel. In addition, the method implementation modes may include additional steps and/or omit the execution of the shown steps. The scope of the present disclosure is not limited in this regard.

As used herein, term “comprise” and its variants should be open-ended, i.e., “comprising but not limited to”. Term “based on” means “based at least in part on”. Term “one embodiment” means “at least one embodiment”; term “another embodiment” means “at least one additional embodiment”; and term “some embodiments” means “at least some embodiments”. Relevant definitions of other terms will be provided in the following text.

It needs to be noted that concepts such as “first”, “second”, and the like mentioned in the present disclosure are only used to distinguish different devices, modules or units, and are not used to limit the order of functions performed by these devices, modules or units, or interdependence relationship.

It should be noted that terms “one” and “multiple” mentioned in the present disclosure are illustrative and not restrictive, and one skilled in the art should understood that the terms should be understood as “one or more” unless the context clearly indicates otherwise.

The names of massages or information exchanged among multiple devices in the embodiments of the present disclosure are only for illustrative purpose, and are not used to limit the range of these messages or the information.

Reference is made to FIG. 1, which is a flowchart of an embodiment of a method for displaying collaboratively edited information according to the present disclosure. As shown in FIG. 1, the method for displaying collaboratively edited information includes steps 11-12.

In step 11, a first identifier display area corresponding to a first content block in an online document is determined in response to an operation of moving an operation focus to the first content block by a first collaborative editor. Content in the first content block is collaboratively editable. The first identifier display area is disposed outside the first content block.

In some embodiments of the present disclosure, the operation of moving the operation focus to the first content block is an operation of editing the first content block, an operation of selecting the first content block, or the like.

In some embodiments of the present disclosure, the online document is a collaboratively editable document created through an online document application.

In some embodiments of the present disclosure, the online document may include at least one content block. The first content block may be any content block in the online document.

In some embodiments of the present disclosure, content in a content block in the online document is collaboratively editable. A user may add or delete a content block in the online document or may add, modify, or delete content in a content block.

In addition, in some embodiments of the present disclosure, the content block may or may not include an outer border. When the content block has a border, the user may further set and change the color of the border of the content block.

In some embodiments of the present disclosure, when the content block has an outer border, the outer border of the content block may be rectangular, square, triangular, circular, or the like. The shape of the outer border of the content block can be set according to an actual requirement and is not specifically limited.

In some embodiments of the present disclosure, the online document may be a collaboratively editable online table. A cell in the online table is regarded as a content block. A comment box may be added to the online table. A comment box and content in the comment box may be regarded as a content block. The content in the comment box is optional. Alternatively, the online document may be a collaboratively editable online Word document. A text paragraph in the Word document is regarded a content block. An editing box in the Word document and content in the editing box are regarded as a content block. The content in the editing box is optional. The Word document may further include a comment box. A comment box and content in the comment box are regarded a content block. Alternatively, the online document may be a collaboratively editable online PPT document. A text paragraph in the collaboratively editable online PPT document is regarded as a content block. An area where an editing box is located may also be regarded as a content block.

In some embodiments of the present disclosure, each identifier display area in the online document may be rectangular. The width of each identifier display area may be a first predetermined value. The length of each identifier area may be a second predetermined value. The first predetermined value and the second predetermined value may be the same or different. The first predetermined value and the second predetermined value are set according to an actual requirement.

In some embodiments of the present disclosure, a ratio of the length of each identifier area to the length of the content block may be a predetermined ratio. The predetermined ratio is greater than zero and less than 1. In this embodiment, the predetermined ratio is 1, to ensure that the identifier display area can display as many and complete identifiers of users as possible.

In some embodiments of the present disclosure, identifier display areas are in a one-to-one correspondence with content blocks in the online document. When a content block is deleted, an identifier display area for the content block is also deleted. When a content block is created, an identifier display area for the content block is also created.

In some embodiments of the present disclosure, the identifier display areas for the content blocks in the online document do not overlap, to ensure that the user can accurately distinguish identifiers of users who collaboratively edit the content blocks at the current moment.

In some embodiments of the present disclosure, the position of each identifier display area is determined according to the position of the content block. In this embodiment, the first identifier display area may be positioned at an outer edge of the first content block. Further, the first identifier display area may be positioned at the upper outer edge or the lower outer edge of the first content block. Still further, the first identifier display area may be aligned with the right side or the left side of the first content block.

In some embodiments of the present disclosure, the first identifier display area being aligned with the right side of the first content block may be understood as that the distance between the right-side boundary of the first identifier display area and the right-side boundary of the first content block in the vertical direction is less than or equal to a predetermined distance. The first identifier display area being aligned with the left side of the first content block may be understood as that the distance between the left-side boundary of the first identifier display area and the left-side boundary of the first content block in the vertical direction is less than or equal to the predetermined distance.

In some embodiments of the present disclosure, the predetermined distance is greater than or equal to 0 cm and less than or equal to 1 cm. Preferably, the predetermined distance may be 0.2 cm, to ensure the aesthetic of the online document.

In some embodiments of the present disclosure, the first identifier display area may alternatively be positioned in the middle of the upper outer edge or the middle of the lower outer edge of the first content block.

In some embodiments of the present disclosure, the first identifier display area may be positioned at the upper outer edge of the first content block and aligned with the right side of the first content block such that the user intuitively knows identifiers of collaborative editors who collaboratively edit the first content block at the current moment.

In some embodiments of the present disclosure, after it is detected that the first collaborative editor among the collaborative editors who have opened the online document moves the operation focus from outside the first content block to any position on the first content block in the online document through touch or a mouse, a position of the first identifier display area corresponding to the first content block in the online document is determined according to a prestored correspondence relationship between a content block and an identifier display area.

In some embodiments of the present disclosure, the first collaborative editor is any collaborative editor who has opened the online document.

In some embodiments of the present disclosure, the correspondence relationship may be a one-to-one correspondence relationship between a position or an identifier of the content block and a position of the identifier display area. The position of the content block may be a center or edge position of the content block. The position of the identifier display area may be a center or boundary position of the identifier display area.

After the position of the first identifier display area is determined, step 12 is performed.

In step 12, an identifier of the first collaborative editor is displayed in the first identifier display area. At least part of an identifier of each collaborative editor is displayed in the first identifier display area.

In some embodiments of the present disclosure, display widths of identifiers of different editors in the first identifier display area may be different or the same.

In some embodiments of the present disclosure, at least part of the identifier of each collaborative editor being displayed in the first identifier display area may be that the identifier of each collaborative editor in the first identifier display area is partially displayed; that the identifier of each collaborative editor in the first identifier display area is completely displayed; or that the identifiers of each collaborative editors of a part of the collaborative editor identifiers in the first identifier display area are partially displayed and the identifiers of each collaborative editors of the remaining collaborative editor identifiers are completely displayed.

In some embodiments of the present disclosure, step 12 may be implemented as follows. It is determined whether an identifier of a collaborative editor exists in the first identifier display area. If no, the identifier of the first collaborative editor is completely displayed on the leftmost side or the rightmost side of the first identifier display area based on the position of the first identifier display area. In other embodiments, the identifier of the first collaborative editor may alternatively be completely displayed at another position in the first identifier area.

In some embodiments of the present disclosure, identifiers of different collaborative editors may be represented by color blocks of different colors. The figure may be rectangular, square, circular, or the like. The identifiers of different collaborative editors may be the same.

In some embodiments of the present disclosure, the identifiers of different collaborative editors may alternatively be represented either by different color blocks each containing a full name of the corresponding collaborative editor or by different color blocks each containing a first character in the name of the corresponding collaborative editor. The color blocks may have a same size and shape. The size of each color block may alternatively be adaptively adjusted based on the length of the name of the collaborative editor. A color block for a collaborative editor with a long name is larger than a color block for a collaborative editor with a short name. The color blocks may be rectangular, square, circular, or the like. The name of the collaborative editor is a username of a user who has registered with online document software.

In some embodiments of the present disclosure, the identifiers of different collaborative editors may alternatively be represented by figures each containing the full name or first character in the name of the corresponding collaborative editor. The figures may be rectangular, square, circular, or the like.

In some embodiments of the present disclosure, the identifier of the collaborative editor may alternatively be represented by a user avatar used by the collaborative editor to register with the online document software.

In some embodiments of the present disclosure, step 12 may be implemented as follows. The identifier of the first collaborative editor is displayed in the first identifier display area according to a predetermined display rule.

In some embodiments of the present disclosure, the predetermined display rule includes: determining a display position of an identifier in the first identifier display area based on a position of an operation focus of a user in a content line of the first content block.

In some embodiments of the present disclosure, the relative position of each identifier in the first identifier display area is continuously adjusted based on the position of the operation focus of each collaborative editor in the content line of the first content block in order of the position of the operation focus of each collaborative editor from left to right, from right to left, from top to bottom, or from bottom to top. A relative positional relationship between the operation focus of each collaborative editor and the corresponding identifier is consistent.

In this way, the relative position of the operation focus of each collaborative editor in the content line of the content block can be quickly determined.

In some embodiments of the present disclosure, when an identifier of a collaborative editor already exists in the first identifier display area, the identifier of the first collaborative editor is displayed on the left side or the right side of the identifier of the existing collaborative editor in the first identifier display area in the chronological order of time when each collaborative editor moves the operation focus to the first content block. Alternatively, the identifier of the first collaborative editor may be displayed above or below the identifier of the existing collaborative editor.

In some embodiments of the present disclosure, the identifiers of the collaborative editors may be arranged in the first identifier display area in the following manner. The identifiers of the collaborative editors are arranged sequentially from left to right, from right to left, from top to bottom, or from bottom to top in the first identifier display area according to the chronological order of each collaborative editor that moves an operation focus to the first content block.

In this way, an order in which the collaborative editors participate in collaborative editing of the first content block can be accurately determined.

In some embodiments of the present disclosure, displaying the identifier of the first collaborative editor on the left side of, on the right side of, above, or below the identifier of the existing collaborative editor includes: displaying a complete identifier of the first collaborative editor on the left side of, on the right side of, above, or below the identifier of the existing collaborative editor; or displaying a partial identifier of the first collaborative editor on the left side of, on the right side of, above, or below the identifier of the existing collaborative editor.

In some embodiments of the present disclosure, displaying the complete identifier of the first collaborative editor on the right side of the identifier of the existing collaborative editor may be implemented as follows.

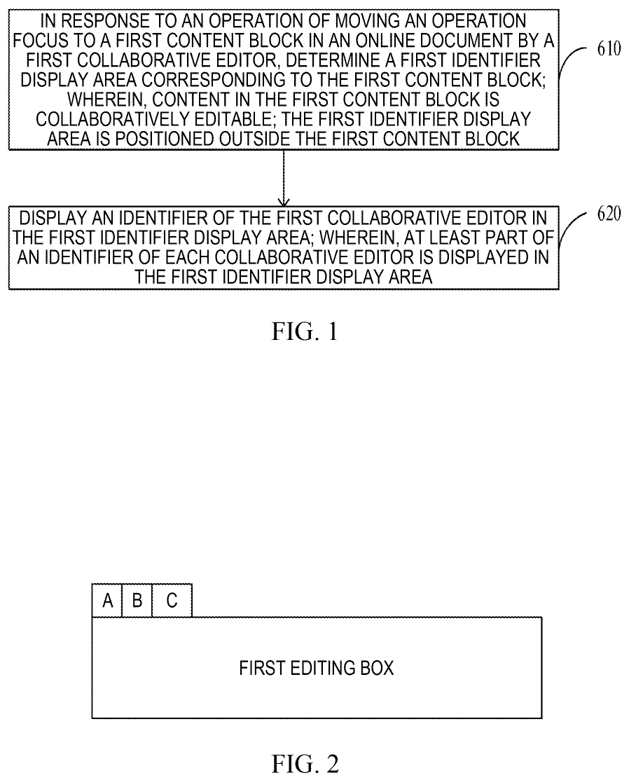

When the existing collaborative editor is displayed to the left in the first identifier display area, the complete identifier of the first collaborative editor is displayed on the right side of and next to the identifier of the existing collaborative editor. As shown in FIG. 2, when identifiers A and B of existing editors are displayed to the left in the first identifier display area, a complete identifier C of the first collaborative editor is displayed on the right side of and next to the identifier B of the existing editor.

In some embodiments of the present disclosure, displaying the complete identifier of the first collaborative editor on the right side of the identifier of the existing collaborative editor may be implemented as follows.

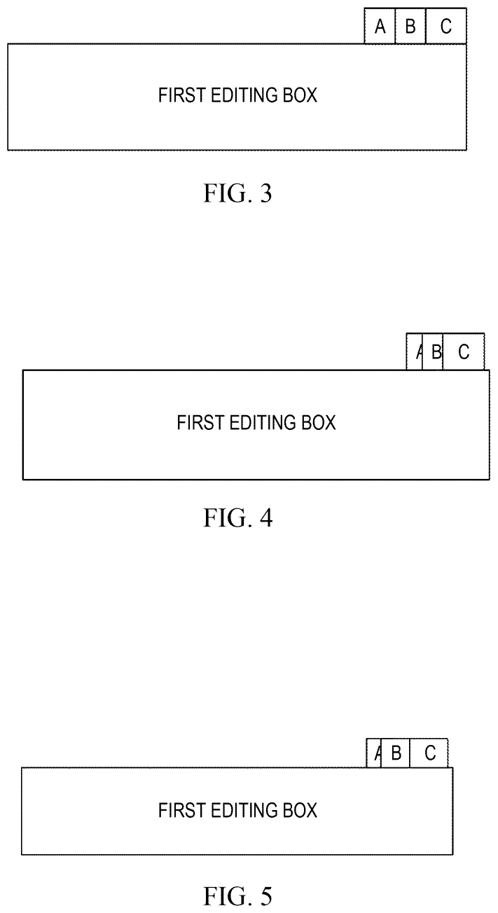

When the existing collaborative editor is displayed to the right in the first identifier display area, the identifier of the existing collaborative editor is moved to the left as a whole by a distance equal to the horizontal width of the identifier of the first collaborative editor, and the complete identifier of the first collaborative editor is displayed on the right side of and next to the moved identifier of the collaborative editor. As shown in FIG. 3, when identifiers A and B of existing editors are displayed to the right in the first identifier display area, a complete identifier C of the first collaborative editor is displayed on the right side of and next to the identifier B of the existing editor.

In some embodiments of the present disclosure, displaying the complete identifier of the first collaborative editor on the right side of the identifier of the existing collaborative editor may be implemented as follows.

As shown in FIG. 4, when the existing collaborative editor is displayed to the right in the first identifier display area, the complete identifier of the first collaborative editor is displayed to the right in the first identifier area. Each of the collaborative edition identifiers of identifiers of the existing collaborative editors are partially hidden for display. The relative position of the identifier of each existing collaborative editor remains unchanged. The identifier of the first collaborative editor is on the right side of and next to the identifier of the existing collaborative editor.

In some embodiments of the present disclosure, displaying the complete identifier of the first collaborative editor on the right side of the identifier of the existing collaborative editor may be implemented as follows.

As shown in FIG. 5, when the existing collaborative editor is displayed to the right in the first identifier display area, the complete identifier of the first collaborative editor is displayed to the right in the first identifier area. The identifier of at least one existing collaborative editor on the right side among the identifiers of the existing collaborative editors is completely displayed. The identifiers of the other existing collaborative editors are partially hidden for display. The relative position of the identifier of each existing collaborative editor remains unchanged. The identifier of the first collaborative editor is on the right side of and next to the identifier of the existing collaborative editor.

In some embodiments of the present disclosure, displaying the complete identifier of the first collaborative editor on the left side of the identifier of the existing collaborative editor may be implemented as follows.

When the existing collaborative editor is displayed to the right in the first identifier display area, the complete identifier of the first collaborative editor is displayed on the left side of and next to the identifier of the existing collaborative editor.

In some embodiments of the present disclosure, displaying the complete identifier of the first collaborative editor on the left side of the identifier of the existing collaborative editor may be implemented as follows.

When the existing collaborative editor is displayed to the left in the first identifier display area, the identifier of the existing collaborative editor is moved to the right as a whole by a distance equal to the horizontal width of the identifier of the first collaborative editor, and the complete identifier of the first collaborative editor is displayed on the left side of and next to the moved identifier of the collaborative editor.

In some embodiments of the present disclosure, displaying the complete identifier of the first collaborative editor on the left side of the identifier of the existing collaborative editor may be implemented as follows.

When the existing collaborative editor is displayed to the left in the first identifier display area, the complete identifier of the first collaborative editor is displayed to the left in the first identifier area. Each of the collaborative edition identifiers of the identifiers of the existing collaborative editors are partially hidden for display. The relative position of the identifier of each existing collaborative editor remains unchanged. The identifier of the first collaborative editor is on the left side of and next to the identifier of the existing collaborative editor.

In some embodiments of the present disclosure, displaying the complete identifier of the first collaborative editor on the left side of the identifier of the existing collaborative editor may be implemented as follows.

When the existing collaborative editor is displayed to the left in the first identifier display area, the complete identifier of the first collaborative editor is displayed to the left in the first identifier area. The identifier of at least one existing collaborative editor on the left side among the identifiers of the existing collaborative editors is completely displayed. The identifiers of the other existing collaborative editors are partially hidden for display. The relative position of the identifier of each existing collaborative editor remains unchanged. The identifier of the first collaborative editor is on the left side of and next to the identifier of the existing collaborative editor.

The identifier of the first collaborative editor is completely displayed in the first identifier area such that the user can accurately determine information about a last collaborative editor to participate in the collaborative editing of the first content block up to the current moment.

In some embodiments of the present disclosure, partially displaying the identifier of the first collaborative editor on the left side or the right side of the identifier of the existing collaborative editor may be implemented as follows.

When the identifier of the existing collaborative editor is displayed to the left in the first identifier display area, the partial identifier of the first collaborative editor is displayed on the right side of and next to the identifier of the existing collaborative editor. Alternatively, when the identifier of the existing collaborative editor is displayed to the right in the first identifier display area, the partial identifier of the first collaborative editor is displayed on the left side of and next to the identifier of the existing collaborative editor.

In some embodiments of the present disclosure, displaying the identifier of the first collaborative editor in the first identifier display area according to the predetermined display rule may alternatively be implemented as follows.

In the first identifier display area, the identifier of the first collaborative editor is randomly displayed on the left or right side of and next to the identifier of any of existing collaborative editors from left to right or from right to left.

The identifier of each collaborative editor is at least partially displayed in the first identifier display area during participation in editing of the first content block such that the user can accurately determine information about the collaborative editors participating in the collaborative editing of the first content block at the current moment.

In some embodiments of the present disclosure, the method further includes: adjusting a color of a border of the first content block and/or a color in the first content block to a first color. The first color is a color of a color block corresponding to a last collaborative editor to move an operation focus to the first content block in the first identifier display area.

In some embodiments of the present disclosure, the color of the border of the first content block in an initial state may be black. The background filling color in the first content block may be white, gray, or the like.

In some embodiments of the present disclosure, after it is detected that a collaborative editor moves an operation focus from outside the first content block to the first content block at the current moment, the color of the border of the first content block may be adjusted to a color of a color block corresponding to the collaborative editor. Alternatively, the background filling color in the border of the first content block may be adjusted to the color of the color block corresponding to the collaborative editor. Alternatively, both the color of the border of and the background filling color in the border of the first content block may be adjusted to the color of the color block corresponding to the collaborative editor.

In this way, the collaborative editors can quickly know the last collaborative editor to participate in the collaborative editing of the first content block up to the current moment.

In some embodiments of the present disclosure, the method for displaying collaboratively edited information further includes: displaying user information of the first collaborative editor near the identifier of the first collaborative editor in response to an operation of moving an operation focus to a position of the identifier of the first collaborative editor by a second collaborative editor.

In some embodiments of the present disclosure, the user information may be name information or name card information of the collaborative editor. The name card information may be in the form of a card, including a name, an email address, a department, or the like of the collaborative editor.

In some embodiments of the present disclosure, displaying the user information of the first collaborative editor near the identifier of the first collaborative editor may include displaying the user information of the first collaborative editor above or below the identifier of the first collaborative editor.

In this way, the user information of each collaborative editor participating in content editing of the first content block can be completely known.

In some embodiments of the present disclosure, the second collaborative editor and the first collaborative editor may be a same user or different users.

In some embodiments of the present disclosure, the second collaborative editor is a user who participates in collaborative editing of the online document described above.

In some embodiments of the present disclosure, when it is detected that the second collaborative editor moves the operation focus from a position other than the position of the identifier of the first collaborative editor to the position of the identifier of the first collaborative editor in the online document, the user information of the first collaborative editor corresponding to the identifier of the first collaborative editor is found based on a prestored correspondence between an identifier and user information of a collaborative editor, and the user information of the first collaborative editor is completely displayed above the identifier of the first collaborative editor. A box containing the user information of the first collaborative editor may further be displayed above the identifier of the first collaborative editor. A connection line may further be displayed between the identifier of the first collaborative editor and the user information of the first collaborative editor. The connection line is used to represent a relationship between the user information of the first collaborative editor and the identifier of the first collaborative editor.

In some embodiments of the present disclosure, the user information of the first collaborative editor displayed in the online document is deleted in response to an operation of moving the operation focus away from the position of the identifier of the first collaborative editor by the second collaborative editor.

In some embodiments of the present disclosure, when the box containing the user information of the first collaborative editor is further displayed above the identifier of the first collaborative editor, the box is deleted. When the connection line corresponding to the identifier of the first collaborative editor is further displayed above the identifier of the first collaborative editor, the connection line is deleted.

In some embodiments of the present disclosure, the identifier of the first collaborative editor displayed in the online document is deleted in response to an operation of moving the operation focus away from a position of the first content block by the first collaborative editor, to ensure that the user can accurately know the information about the editors participating in the collaborative editing of the first content block.

In some embodiments of the present disclosure, the method further includes: displaying a collaborator information panel in response to a trigger operation of a third collaborative editor on the first identifier display area. The information panel includes user information of a collaborative editor corresponding to each identifier in the first identifier display area.

In some embodiments of the present disclosure, an operation of clicking or selecting the first identifier display area through a cursor by the third collaborative editor may be determined as the trigger operation on the first identifier display area.

In some embodiments of the present disclosure, in response to the trigger operation of the third collaborative editor on the first identifier display area, the user information of the collaborative editor corresponding to each identifier in the first identifier display area is found, and then the collaborator information panel is displayed near the first identifier display area based on the found user information of the collaborative editor and the position of the first identifier display area.

In some embodiments of the present disclosure, the third collaborative editor may be the first collaborative editor, the second collaborative editor, or another collaborative editor.

Further referring to FIG. 6, as an implementation of the method shown in the foregoing figures, the present disclosure provides an embodiment of an apparatus for displaying collaboratively edited information. The apparatus embodiment corresponds to the method embodiment shown in FIG. 1. The apparatus can be specifically applied to various electronic devices.

As shown in FIG. 6, the apparatus for displaying collaboratively edited information in this embodiment includes a response unit 610 and a display unit 620. The response unit 610 is configured to determine, in response to an operation of moving an operation focus to a first content block in an online document by a first collaborative editor, a first identifier display area corresponding to the first content block. Content in the first content block is collaboratively editable. The first identifier display area is positioned outside the first content block. The display unit 620 is configured to display an identifier of the first collaborative editor in the first identifier display area. At least part of an identifier of each collaborative editor is displayed in the first identifier display area.

In some embodiments of the present disclosure, for specific processing of the response unit 610 and the display unit 620, reference may be made to the foregoing method embodiment. Details are not described herein again.

In some embodiments of the present disclosure, the display unit is specifically configured to display the identifier of the first collaborative editor in the first identifier display area according to a predetermined display rule.

In some embodiments of the present disclosure, the predetermined display rule includes: determining a display position of an identifier in the first identifier display area based on a position of an operation focus of a user in a content line of the first content block.

In some embodiments of the present disclosure, the display unit is further configured to display the identifier of the first collaborative editor on a side of an identifier of an existing collaborative editor in the first identifier display area according to a chronological order of each collaborative editor that moves an operation focus to the first content block.

In some embodiments of the present disclosure, displaying the identifier of the first collaborative editor on the side of the identifier of the existing collaborative editor includes: displaying a complete identifier of the first collaborative editor on the side of the identifier of the existing collaborative editor.

In some embodiments of the present disclosure, displaying the complete identifier of the first collaborative editor on the side of the identifier of the existing collaborative editor includes: displaying the complete identifier of the first collaborative editor on the side of the identifier of the existing collaborative editor and hiding a part of each collaborative edition identifiers of the identifiers of the existing collaborative editors.

In some embodiments of the present disclosure, identifiers of different editors in the first identifier display area have different display widths.

In some embodiments of the present disclosure, the first identifier display area is positioned at an outer edge of the first content block.

In some embodiments of the present disclosure, the first identifier display area is aligned with the right side or the left side of the first content block.

In some embodiments of the present disclosure, identifiers of different collaborative editors are represented by different color blocks each containing a name of the corresponding collaborative editor.

In some embodiments of the present disclosure, the apparatus further includes an adjustment unit configured to adjust a color of a border of the first content block and/or a background filling color in the first content block to a first color. The first color is a color of a color block corresponding to a last collaborative editor to move an operation focus to the first content block in the first identifier display area.

In some embodiments of the present disclosure, the apparatus further includes a user information display unit configured to display user information of the first collaborative editor near the identifier of the first collaborative editor in response to an operation of moving an operation focus to a position of the identifier of the first collaborative editor by a second collaborative editor.

In some embodiments of the present disclosure, the apparatus further includes an information panel display unit configured to display a collaborator information panel in response to a trigger operation of a third collaborative editor on the first identifier display area. The information panel includes user information of a collaborative editor corresponding to each identifier in the first identifier display area.

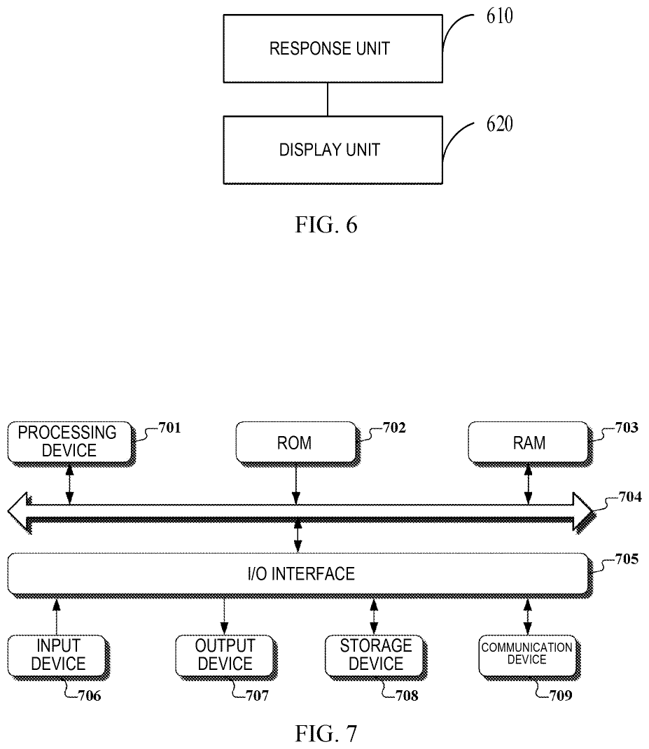

Refer to FIG. 7, which shows a schematic diagram of an electronic device according to an embodiment of the present disclosure. The terminal device in the embodiment of the present disclosure may include but is not limited to a mobile terminal, such as a mobile phone, a notebook computer, a digital broadcast receiver, a personal digital assistant (PDA), a tablet computer (PAD), a portable multimedia player (PMP), an vehicle-mounted terminal (such as a vehicle-mounted navigation terminal), and a fixed terminal, such as a digital TV and a desktop computer. The electronic device shown in FIG. 7 is only an example, and should not limit the function and disclosure range of the embodiments of the present disclosure.

As shown in FIG. 7, the electronic device may include a processing apparatus (such as a central processing unit, a graphics processing unit, or the like) 701 that may perform various appropriate actions and processing according to a program stored in a read-only memory (ROM) 702 or a program loaded from a storage apparatus 708 into a random-access memory (RAM) 703. In the RAM 703, various programs and data required for operation of the electronic device are further stored. The processing apparatus 701, the ROM 702, and the RAM 703 are connected to each other by using a bus 704. An input/output (I/O) interface 705 is also connected to the bus 704.

Generally, the following apparatuses may be connected to the I/O interface 705: input apparatuses 706 including, for example, a touchscreen, a touchpad, a keyboard, a mouse, a camera, a microphone, an accelerometer, and a gyroscope; output apparatuses 707 including, for example, a liquid crystal display (LCD), a loudspeaker and a vibrator; storage apparatuses 708 including, for example, a tape or a hard disk; and a communications apparatus 709. The communications apparatus 709 may allow the electronic device to communicate wirelessly or wiredly with another device to exchange data. Although FIG. 7 shows an electronic device with various apparatuses, it should be understood that it is not required to implement or provide all shown apparatuses. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer software program product that includes a computer program carried on a readable medium, and the computer program includes program codes used to perform the methods shown in the flowchart. In such an embodiment, the computer program may be downloaded and installed from a network by using the communications apparatus 709, installed from the storage apparatus 708, or installed from the ROM 702. When the computer program is executed by the processing apparatus 701, the foregoing functions defined in the method in the embodiments of the present disclosure are executed.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or device, or any combination thereof. More specific examples of the computer-readable storage medium may include but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. In the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or device. The program code included in the computer-readable medium may be transmitted by using any suitable medium, including but not limited to: a wire, an optical cable, a radio frequency (RF), or any suitable combination thereof.

In some embodiments, the client and the server can communicate by using any currently known or future-developed network protocol, for example, an HTTP (Hyper Text Transfer Protocol), and can be interconnected by a communication network of any form or any medium. Examples of the communication network include a local area network (LAN), a wide area network (WAN), an internet network (for example, the Internet), and an end-to-end network (for example, an ad hoc end-to-end network), and any currently known or future-developed network.

The computer readable medium may be included in the foregoing electronic device, or may exist separately and not be assembled into the electronic device.

The computer readable medium may be included in the foregoing electronic device, or may exist separately and not be assembled into the electronic device.

The computer-readable medium carries one or more programs. The one or more programs, when executed by the electronic device, enable the electronic device to determine, in response to an operation of moving an operation focus to a first content block in an online document by a first collaborative editor, a first identifier display area corresponding to the first content block; and display an identifier of the first collaborative editor in the first identifier display area. The first content block is a collaboratively editable content block. Content blocks in the online document are in a one-to-one correspondence with identifier display areas. The first identifier display area is positioned outside the first content block. At least part of an identifier of each collaborative editor is displayed in the first identifier display area.

In some implementations, displaying the identifier of the first collaborative editor in the first identifier display area includes: displaying the identifier of the first collaborative editor in the first identifier display area according to a predetermined display rule.

In some implementations, the predetermined display rule includes: determining a display position of an identifier in the first identifier display area based on a position of an operation focus of a user in a content line of the first content block.

In some implementations, displaying the identifier of the first collaborative editor in the first identifier display area according to the predetermined display rule includes: displaying the identifier of the first collaborative editor on a side of an identifier of an existing collaborative editor in the first identifier display area in chronological order of time when each collaborative editor moves an operation focus to the first content block.

In some implementations, displaying the identifier of the first collaborative editor on the side of the identifier of the existing collaborative editor includes: displaying a complete identifier of the first collaborative editor on the side of the identifier of the existing collaborative editor.

In some implementations, displaying the identifier of the first collaborative editor on the side of the identifier of the existing collaborative editor includes: displaying a complete identifier of the first collaborative editor on the side of the identifier of the existing collaborative editor and hiding a part of each collaborative edition identifiers of the identifiers of the existing collaborative editors.

In some implementations, identifiers of different editors in the first identifier display area have different display widths.

In some implementations, the first identifier display area is positioned at an outer edge of the first content block.

In some implementations, the first identifier display area is aligned with the right side or the left side of the first content block.

In some implementations, identifiers of different collaborative editors are represented by different color blocks each containing a name of the corresponding collaborative editor.

In some implementations, the one or more programs, when executed by the electronic device, enable the electronic device to adjust a color of a border of the first content block and/or a background filling color in the first content block to a first color. The first color is a color of a color block corresponding to a last collaborative editor to move the operation focus to the first content block in the first identifier display area.

In some implementations, the one or more programs, when executed by the electronic device, enable the electronic device to display user information of the first collaborative editor near the identifier of the first collaborative editor in response to an operation of moving an operation focus to a position of the identifier of the first collaborative editor by a second collaborative editor.

In some implementations, the one or more programs, when executed by the electronic device, enable the electronic device to display a collaborator information panel in response to a trigger operation of a third collaborative editor on the first identifier display area. The information panel includes user information of a collaborative editor corresponding to each identifier in the first identifier display area.

Computer program codes for performing the operations of the present disclosure may be written in one or more programming languages or a combination thereof, such as object-oriented programming languages Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

Flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. The names of these units do not limit the units themselves under certain circumstances.

Various functions described herein above can be implemented by one or more hardware logic members. For example and without limitations thereto, an exemplary hardware logic member includes a field programmable gate array (FPGA), an disclosure-specific integrated circuit (ASIC), an disclosure-specific standard product (ASSP), a system-on-chip system (SOC), a complex programmable logic device (CPLD) or the like.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. Machine-readable media may include, but are not limited to, electronic, magnetic, optical, electromagnetic, infrared, or semiconductor systems, apparatuses or devices, or any suitable combination of the foregoing. More specific examples of machine-readable storage media would include one or more wire-based electrical connections, portable computer disks, hard disks, random-access memories (RAMs), read-only memories (ROMs), erasable programmable read-only memories (EPROM or flash memories), fiber optics, portable compact disk read only memories (CD-ROMs), optical storage devices, magnetic storage devices, or any suitable combination of the foregoing.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, while the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logical actions, it should be understood that the subject matter limited in the appended claims is not necessarily limited to the particular features or actions described above. Rather, the particular features and actions described above are merely example forms of implementing the claims.

The embodiments of the present disclosure provide the method and apparatus for displaying collaboratively edited information, electronic device, and readable medium. The first identifier display area corresponding to the first content block in the online document is determined in response to the operation of moving the operation focus to the first content block by the first collaborative editor. The content in the first content block is collaboratively editable. The first identifier display area is positioned outside the first content block. The identifier of the first collaborative editor is displayed in the first identifier display area. At least part of the identifier of each collaborative editor is displayed in the first identifier display area. For any content block, at least part of an identifier of each collaborative editor of the content block is displayed in an identifier display area corresponding to the content block. Thus, the user can accurately identify information about collaborative editors participating in collaborative editing of content in any content block in the online document based on at least part of an identifier of each collaborative editor in an identifier display area corresponding to the content block.

1-16. (canceled)

17. An information presentation method for collaborative editing, comprising:
in response to an operation of moving an operation focus to a first content block in an online document by a first collaborative editor, determining a first identifier display area corresponding to the first content block; wherein, content in the first content block is collaboratively editable; the first identifier display area is positioned outside the first content block; and
displaying an identifier of the first collaborative editor in the first identifier display area, at least part of an identifier of each collaborative editor being displayed in the first identifier display area.

18. The method of claim 17, wherein displaying the identifier of the first collaborative editor in the first identifier display area comprises:
displaying the identifier of the first collaborative editor in the first identifier display area according to a predetermined display rule.

19. The method of claim 18, wherein the predetermined display rule comprises: determining a display position of an identifier in the first identifier display area based on a position of an operation focus of a user in a content row of the first content block.

20. The method of claim 18, wherein displaying the identifier of the first collaborative editor in the first identifier display area according to the predetermined display rule comprises:
according to a chronological order of each collaborative editor that moves an operation focus to the first content block, displaying the identifier of the first collaborative editor on a side of an identifier of an existing collaborative editor in the first identifier display area.

21. The method of claim 20, wherein displaying the identifier of the first collaborative editor on the side of the identifier of the existing collaborative editor comprises:
displaying a complete identifier of the first collaborative editor on the side of the identifier of the existing collaborative editor.

22. The method of claim 20, wherein displaying the identifier of the first collaborative editor on the side of the identifier of the existing collaborative editor comprises:
displaying a complete identifier of the first collaborative editor on the side of the identifier of the existing collaborative editor and hiding a part of each collaborative edition identifier of the identifier of the existing collaborative editor.

23. The method of claim 17, wherein identifiers of different editors in the first identifier display area have different display widths.

24. The method of claim 17, wherein the first identifier display area is positioned at an outer edge of the first content block.

25. The method of claim 24, wherein the first identifier display area is aligned with a right side or a left side of the first content block.

26. The method of claim 17, wherein identifiers of different collaborative editors are represented by different color blocks each containing a name of a corresponding collaborative editor.

27. The method of claim 26, further comprising:
adjusting a color of a border of the first content block and/or a background filling color in the first content block to a first color; wherein, the first color is a color of a color block corresponding to a last collaborative editor that moved an operation focus to the first content block in the first identifier display area.

28. The method of claim 17, further comprising:
in response to an operation of moving an operation focus to a position of the identifier of the first collaborative editor by a second collaborative editor, displaying user information of the first collaborative editor near the identifier of the first collaborative editor.

29. The method of claim 17, further comprising:
in response to a trigger operation on the first identifier display area by a third collaborative editor, displaying a collaborator information panel, the information panel comprising: user information of a collaborative editor corresponding to each identifier in the first identifier display area.

30. An electronic device, comprising:
one or more processors; and
a storage apparatus, configured to store one or more programs;
the one or more programs, in response to being executed by the one or more processors, causing the one or more processors to implement a method comprising:
in response to an operation of moving an operation focus to a first content block in an online document by a first collaborative editor, determining a first identifier display area corresponding to the first content block; wherein, content in the first content block is collaboratively editable; the first identifier display area is positioned outside the first content block; and
displaying an identifier of the first collaborative editor in the first identifier display area, at least part of an identifier of each collaborative editor being displayed in the first identifier display area.

31. The electronic device of claim 30, wherein displaying the identifier of the first collaborative editor in the first identifier display area comprises:
displaying the identifier of the first collaborative editor in the first identifier display area according to a predetermined display rule.

32. The electronic device of claim 31, wherein the predetermined display rule comprises: determining a display position of an identifier in the first identifier display area based on a position of an operation focus of a user in a content row of the first content block.

33. The electronic device of claim 31, wherein displaying the identifier of the first collaborative editor in the first identifier display area according to the predetermined display rule comprises:
according to a chronological order of each collaborative editor that moves an operation focus to the first content block, displaying the identifier of the first collaborative editor on a side of an identifier of an existing collaborative editor in the first identifier display area.

34. The electronic device of claim 33, wherein displaying the identifier of the first collaborative editor on the side of the identifier of the existing collaborative editor comprises:
displaying a complete identifier of the first collaborative editor on the side of the identifier of the existing collaborative editor.

35. The electronic device of claim 33, wherein displaying the identifier of the first collaborative editor on the side of the identifier of the existing collaborative editor comprises:
displaying a complete identifier of the first collaborative editor on the side of the identifier of the existing collaborative editor and hiding a part of each collaborative edition identifier of the identifier of the existing collaborative editor.

36. A non-transitory computer-readable medium, storing a computer program thereon, wherein the program, in response to being executed by a processor, implements a method comprising:
in response to an operation of moving an operation focus to a first content block in an online document by a first collaborative editor, determining a first identifier display area corresponding to the first content block; wherein, content in the first content block is collaboratively editable; the first identifier display area is positioned outside the first content block; and
displaying an identifier of the first collaborative editor in the first identifier display area, at least part of an identifier of each collaborative editor being displayed in the first identifier display area.
